(19) United States
(12) Patent Application Publication
(10) Pub. No.: US 2018/0354307 A1
(43) Pub. Date: Dec. 13, 2018

(54) Pneumatic Tire, Having Working Layers Comprising Monofilaments And A Tire Tread With Incisions

(71) Applicant: COMPAGNIE GENERALE DES ETABLISSEMENTS MICHELIN, Clermont-Ferrand (FR)

(72) Inventors: Aymeric BONNET, Clermont-Ferrand Cedex 9 (FR); Jean-Charles DEROBERT-MAZURE, Clermont-Ferrand Cedex 9 (FR); Jacques MOREL-JEAN, Clermont-Ferrand Cedex 9 (FR)

(21) Appl. No.: 15/771,292

(22) PCT Filed: Oct. 26, 2016
(86) PCT No.: PCT/EP2016/075721

§ 371 Date: Apr. 26, 2018

(30) Foreign Application Priority Data
Oct. 27, 2015 (FR) 1560234

(51) Int. Cl. B60C 9/20; B60C 11/04; B60C 11/12; B60C 9/18; B60C 9/00; B60C 9/22

(52) U.S. Cl. CPC B60C 9/2009; B60C 2009/0085; B60C 11/1204; B60C 11/1236; B60C 11/1259; B60C 11/1272; B60C 9/1807; B60C 9/0007; B60C 9/0042; B60C 9/0064; B60C 9/22; B60C 2011/1213; B60C 2011/1254; B60C 2011/129; B60C 2009/1828; B60C 2009/2016; B60C 2009/2019; B60C 2009/2077; B60C 2009/2083; B60C 2009/209; B60C 11/04

(57) ABSTRACT

Technique to increase the endurance of tires comprising two crossed working layers (41, 42), comprising mutually parallel reinforcing elements that form, with the circumferential direction (XX′) of the tire, an angle which is at least equal to 20° and at most equal to 50°. The reinforcing elements are made up of individual metal threads or monofilaments having a cross section which is at least equal to 0.20 mm and at most equal to 0.5 mm. The tire also comprises axially exterior sipes (24) having a mean width W at most equal to 1 mm, of a depth D at least equal to 5 mm and spaced apart, in the circumferential direction (XX′), by a circumferential spacing P at least equal to 4 mm, and axially exterior grooves (25) having a mean width W at least equal to 1 mm, of a depth D at most equal to 5 mm.

### FIELD OF THE INVENTION

The present invention relates to a passenger vehicle tire and more particularly to the crown of such a tire.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively.

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

A tire comprises a crown comprising a tread that is intended to come into contact with the ground via a tread surface, two beads that are intended to come into contact with a rim, and two sidewalls that connect the crown to the beads. Furthermore, a tire comprises a carcass reinforcement, comprising at least one carcass layer, radially on the inside of the crown and connecting the two beads.

The tread of a tire is delimited, in the radial direction, by two circumferential surfaces of which the radially outermost is referred to as the tread surface and of which the radially innermost is referred to as the tread pattern bottom surface. In addition, the tread of a tire is delimited, in the axial direction, by two lateral surfaces. The tread is also made up of one or more rubber compounds. The expression “rubber compound” refers to a composition of rubber comprising at least one elastomer and a filler.

The crown comprises at least one crown reinforcement radially on the inside of the tread. The crown reinforcement comprises at least one working reinforcement, comprising at least one working layer made up of mutually parallel reinforcing elements that form, with the circumferential direction, an angle of between 15° and 50°. The crown reinforcement may also comprise at least one hooping layer made up of reinforcing elements that form, with the circumferential direction, an angle of between 0° and 10°, the hoop reinforcement usually, although not necessarily, being radially on the outside of the working layers.

In order to obtain good grip on wet ground, cuts are made in the tread. A cut denotes either a well, or a groove, or a sipe, or a circumferential groove and forms a space opening onto the tread surface. On the tread surface, a well has no characteristic main dimension. A sipe or a groove has, on the tread surface, two characteristic main dimensions: a width W and a length Lo, such that the length Lo is at least equal to twice the width W thereof. A sipe or a groove is therefore delimited by at least two main lateral faces determining its length Lo and connected by a bottom face, the two main lateral faces being distant from one another by a non-zero distance referred to as the width W of the sipe or of the groove.

By definition, a sipe or a groove which is delimited by:
only two main lateral faces is said to be open-ended,
by three lateral faces, two of them being main faces determining the length of the cut, is said to be blind,
by four lateral faces, two of them being main faces determining the length of the cut, is said to be double-blind.

The difference between a sipe and a groove is the value of the mean distance separating the two main lateral faces of the cut, namely its width W. In the case of a sipe, this distance is suitable for allowing the two mutually-facing main lateral faces to come into contact when the sipe enters the contact patch in which the tire is in contact with the road surface. In the case of a groove, the main lateral faces of this groove cannot come into contact with one another under usual running conditions. This distance for a sipe is generally, for passenger vehicle tires, at most equal to 1 millimetre (mm). A circumferential groove is a cut of substantially circumferential direction, that is substantially continuous, over the entire circumference of the tire.

More specifically, the width W is the mean distance, determined along the length of the cut and along a radial portion of the cut, comprised between a first circumferential surface, radially on the inside of the tread surface at a radial distance of 1 mm, and a second circumferential surface, radially on the outside of the bottom surface at a radial distance of 1 mm, so as to avoid any measurement problem associated with the junctions at which the two main lateral faces meet the tread surface and the bottom surface.

The depth of the cut is the maximum radial distance between the tread surface and the bottom of the cut. The maximum value of the depths of the cuts is referred to as the tread depth D. The tread pattern bottom surface is defined as being the surface of the tread surface translated radially inwards by a radial distance equal to the tread depth.

### PRIOR ART

In the current context of sustainable development, the saving of resources and therefore of raw materials is one of the industry's key objectives. For passenger vehicle tires, one of the avenues of research for achieving this objective is to replace the metal cords usually employed as reinforcing elements in various layers of the crown reinforcement with individual threads or monofilaments as described in document EP 0043563 in which this type of reinforcing element is used with the twofold objective of saving weight and lowering rolling resistance.

However, the use of this type of reinforcing element has the disadvantage of causing a problem of buckling under compression, causing the tire to exhibit insufficient endurance, as described in document EP2537686. As that same document describes, a person skilled in the art proposes a particular layout of the various layers of the crown reinforcement, a specific quality of the materials that make up the reinforcing elements of the crown reinforcement in order to solve this problem.

A fine analysis of the physical phenomenon shows that the buckling of the monofilaments occurs in the axially outermost parts of the tread underneath the cuts, as mentioned in document JP 2012071791. This region of the tire has the particular feature of being subjected to high compression loadings when the vehicle is running in a curved line. The resistance of the monofilaments to buckling is dependent on the geometry of the cuts, thus demonstrating the surprising influence that the tread pattern has on the endurance of the monofilaments.

### SUMMARY OF THE INVENTION

The key objective of the present invention is therefore to increase the endurance of a tire the working layer reinforcing elements of which are made up of monofilaments, through the design of a suitable tread pattern for the tread.

This objective is achieved by a passenger vehicle tire comprising:
a tread intended to come into contact with the ground via a tread surface and having an axial width LT,
the tread comprising two axially exterior portions each having an axial width at most equal to 0.3 times the axial width LT,
at least one axially exterior portion comprising axially exterior cuts, an axially exterior cut forming a space opening onto the tread surface and being delimited by at least two main faces referred to as lateral faces connected by a bottom face,
the axially exterior cuts having a mean width W defined by the distance between the two main lateral faces, a depth D defined by the maximum radial distance between the tread surface and the bottom face,
the tire further comprising a crown reinforcement radially on the inside of the tread,
the crown reinforcement comprising a working reinforcement and a hoop reinforcement,
the working reinforcement being made up of two working layers each comprising reinforcing elements which are coated in an elastomeric material, mutually parallel and respectively form, with a circumferential direction (XX′) of the tire, an oriented angle at least equal to 20° and at most equal to 50°, in terms of absolute value, and of opposite sign from one layer to the next,
the said reinforcing elements in each ply being made up of individual metal threads or monofilaments having a cross section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm,
the hoop reinforcement comprising at least one hooping layer comprising reinforcing elements which are mutually parallel and form, with the circumferential direction (XX′) of the tire, an angle B at most equal to 10°, in terms of absolute value,
when the axially exterior cuts have a mean width W at most equal to 1 mm, these axially exterior cuts, referred to as sipes, have a depth D at least equal to 5 mm and are spaced apart, in the circumferential direction (XX′) of the tire, by a circumferential spacing P at least equal to 4 mm,
when the axially exterior cuts have a mean width W at least equal to 1 mm, these axially exterior cuts, referred to as grooves, have a depth D at most equal to 5 mm,
the breaking strength R_{c} of each working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

Usually, the main lateral faces are substantially of the same shape and distant from one another by a distance equal to the width W of the cut.

For cuts of complex shape, what is meant by the width of the cut is the mean distance between the main lateral faces averaged over the mean curved length of the main lateral faces of the cut.

From a mechanical operation standpoint, the buckling of a reinforcing element occurs in compression. It occurs only radially on the inside of the axially outermost portions of the tread because it is in this zone that the compressive loadings are highest in the event of transverse loading. These axially outermost portions each have as their maximum axial width 0.3 times the total width of the tread of the tire.

Buckling is a complex and unstable phenomenon which leads to fatigue rupture of an object that has at least one dimension one order of magnitude smaller than a main dimension, such as beams or shells. Monofilaments are objects of this type with a cross section very much smaller than their length. The phenomenon begins when the main dimension is placed under compression. It continues because of the asymmetry of geometry of the monofilament, or because of the existence of a transverse force caused by the bending of the monofilament, which is a stress loading that is highly destructive for metallic materials. This complex phenomenon is notably highly dependent on the boundary conditions, on the mobility of the element, on the direction of the applied load and on the deformation resulting from this load. If this deformation does not take place substantially in the direction of the main dimension of the monofilament, then buckling will not occur and, in the case of monofilaments surrounded by a matrix of rubber compound of the working layers of a tire, the load is absorbed by the shearing of the rubber compound between the monofilaments.

In addition, the buckling of the monofilaments of the working layers occurs only in the most flexible portions of the tread. These portions may correspond to axially exterior portions of the tread comprising axially exterior cuts, of a width at least equal to 1 mm and of a depth D at least equal to 5 mm, namely grooves. These portions may also correspond to axially exterior portions of the tread having a high density of narrow cuts, namely sipes of depth D at least equal to 5 mm and spaced apart, in the circumferential direction (XX′) of the tire, by a circumferential spacing P at most equal to 4 mm. The circumferential spacing is the mean circumferential distance, over the relevant axially outermost portion of the tread, between the mean linear profiles of two circumferentially consecutive axially exterior sipes. Usually, the treads of tires may have circumferential spacings that are variable notably so as to limit road noise.

One solution for avoiding the buckling of the monofilaments in the working layers is for the axially exterior cuts to have a width less than 1 mm so that they close in the contact patch and therefore protect the monofilaments from buckling, but for them to be spaced apart, in the circumferential direction (XX′) of the tire by a circumferential spacing P at least equal to 4 mm, so as to avoid a softening of the portion of the tread.

It is also necessary for the grooves, cuts of a width at least equal to 1 mm, to have a depth D at most equal to 5 mm.

In the case of the cuts that are not axially exterior, the compressive loading in the case of transverse loading of the tire is too low to cause buckling. Moreover, it is common practice in passenger vehicle tires for only sipes of a width less than 1 mm to be arranged in the axially central parts of the tread.

The axially exterior cuts may have any shape, curved, sinusoidal, zigzag, and may or may not by a suitable design allow relative movements of their main lateral faces during running. In order to prevent relative movement of the main lateral faces of a cut, all that is required is to create a tread element that is such that one of the faces will come to press against the other when the movement in question is likely to occur. Sipes cut as a zigzag or a sinusoid along the length of the cut, if the two main lateral faces are designed to press against one another, are examples of this type of cut. If the waviness of the sipe is in the depth wise direction, the relative radial movement of the main lateral faces will be blocked. If the sipe has two sets of undulation, in the lengthwise direction and in the depth wise direction, then both movements will be blocked. Insofar as it is a large movement allowed to the crown which causes the monofilaments of the working layers to buckle, particularly movements permitted by the tread pattern, any blocking of movement in the tread pattern may lead to an improvement in the endurance performance of the monofilaments.

The two axially exterior portions of the tread may potentially contain one or more circumferential grooves in order to reduce the risk of aquaplaning on wet ground. For passenger vehicle tires, these circumferential grooves generally represent a small width of the contact patch and have no known impact on the buckling of the monofilaments.

The monofilaments may have any cross-sectional shape, in the knowledge that oblong cross sections represent an advantage over circular cross sections, even when of smaller size, because their second moment of area in bending and, therefore, their resistance to buckling, are higher. In the case of a circular cross section, the smallest dimension corresponds to the diameter of the cross section. In order to guarantee the fatigue breaking strength of the monofilaments and the resistance to shearing of the rubber compounds situated between the filaments, the density of reinforcing elements of each working layer is at least equal to 100 threads per dm and at most equal to 200 threads per dm. What is meant by the density is the mean number of monofilaments over a 10-cm width of the working layer, this width being measured perpendicularly to the direction of the monofilaments in the working layer considered. The distance between consecutive reinforcing elements may be fixed or variable. The reinforcing elements may be laid during manufacture either in layers, in strips, or individually.

Furthermore, the resistance of a monofilament to buckling is also dependent on the resistance of the axially adjacent filaments, the onset of buckling in one being able to lead to the buckling of another through the effect of a distribution of load around the monofilament that is buckling. In order to obtain improved endurance performance, it is appropriate not only to observe monofilament density and diameter conditions but also to satisfy a condition relating to the strength of the working layer, namely the breaking strength R_{c} of each working layer which needs to be at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

For a tire for which no specific direction of mounting is imposed, the solution involves applying the invention to the two axially outermost portions of the tread.

For a tire for which a specific direction of mounting is imposed, one option is to apply the invention to only that axially outermost portion of the tread that is situated on the outboard side of the vehicle.

The tread patterns of passenger vehicle tires are usually either substantially symmetric or substantially antisymmetric, or substantially asymmetric.

It is advantageous for an axially exterior cut to open axially onto the outside of an axially exterior portion of the tread so as to be able to remove the water stored in the cut to the outside of the contact patch when running on a wet road surface.

For preference, when the tread comprises at least one circumferential groove, an axially exterior cut opens axially into a circumferential groove of the tread so as to be able to remove the water stored in the cut to the main water-storage means when running on a wet road surface.

For grip performance, it is also preferable for the axially exterior sipes to be spaced apart, in the circumferential direction [XX′] of the tire, by a circumferential spacing P at most equal to 20 mm, so as to avoid having too low a sipes density, leading to inadequate grip performance.

A preferred solution is for an axially exterior sipe to be bridged. A bridge of rubber in a cut corresponds to a local reduction in the depth of this cut. This very simple solution makes it possible to limit the relative movements of the main lateral faces in all directions. On the other hand, it has the disadvantage of opposing flattening and therefore of penalising the rolling resistance and of opposing the circulation of water in the bottom of the cut. In order to facilitate flattening and thus improve the rolling resistance, the bridges of rubber may comprise a sipe.

For preference, the depth D of the axially exterior sipes is at most equal to 8 mm in order to avoid excessive flexibility of the tread pattern and loss of wearing and rolling-resistance performance.

It is particularly advantageous for the radial distance D1 between the bottom face of the axially exterior sipes and the crown reinforcement to be at least equal to 1.5 mm. This is because this minimal quantity of rubbery material protects the crown from attack and puncturing by obstacles, stones, or any debris lying on the ground.

It is preferable for the radial distance D1 between the bottom face of the axially exterior sipes and the crown reinforcement to be at most equal to 3.5 mm in order to obtain a tire that performs well in terms of rolling resistance.

One preferred solution, in particular in terms of noise performance, is for all of the axially exterior cuts to be sipes.

Advantageously, the two axially exterior portions of the tread each have an axial width (LS1, LS2) at most equal to 0.2 times the axial width LT of the tread.

For preference, each working layer comprises reinforcing elements made up of individual metal threads or monofilaments having a cross section the smallest dimension of which is at least equal to 0.3 mm and at most equal to 0.37 mm, which constitute an optimum for balancing the target performance aspects: weight saving and buckling endurance of the reinforcing elements of the working layers.

One preferred solution is for each working layer to comprise reinforcing elements which form, with the circumferential direction (XX′) of the tire, an angle at least equal to 22° and at most equal to 35°, which constitute an optimal compromise between tire behaviour and tire endurance performance.

It is advantageous for the density of reinforcing elements in each working layer to be at least equal to 120 threads per dm and at most equal to 180 threads per dm in order to guarantee the endurance of the rubber compounds working in shear between the reinforcing elements and the tension and compression endurance thereof.

The reinforcing elements of the working layers may or may not be rectilinear. They may be preformed, of sinusoidal, zigzag, or wavy shape, or following a spiral. The reinforcing elements of the working layers are made of steel, preferably carbon steel such as those used in cords of the “steel cords” type, although it is of course possible to use other steels, for example stainless steels, or other alloys.

When a carbon steel is used, its carbon content (% by weight of steel) is preferably comprised in a range from 0.8% to 1.2%. The invention is particularly applicable to steels of the very high strength (referred to as “SHT” for “Super High Tensile”), ultra-high strength (referred to as “UHT” for “Ultra High Tensile” or “MT for “Mega Tensile”) steel cord type. The carbon steel reinforcers then have a tensile strength (Rm) preferably higher than 3000 MPa, more preferably higher than 3500 MPa. Their total elongation at break (At), which is the sum of the elastic elongation and the plastic elongation, is preferably greater than 2.0%.

As far as the steel reinforcers are concerned, the measurements of breaking strength, denoted Rm (in MPa), and elongation at break, denoted At (total elongation in %), are taken under tension in accordance with ISO standard 6892 of 1984.

The steel used, whether it is in particular a carbon steel or a stainless steel, may itself be coated with a layer of metal which improves for example the workability of the steel monofilament or the wear properties of the reinforcer and/or of the tire themselves, such as properties of adhesion, corrosion resistance or even resistance to ageing. According to one preferred embodiment, the steel used is covered with a layer of brass (Zn—Cu alloy) or of zinc; it will be recalled that during the process of manufacturing the wire threads, the brass or zinc coating makes the wire easier to draw, and makes the wire thread adhere to the rubber better. However, the reinforcers could be covered with a thin layer of metal other than brass or zinc, having for example the function of improving the corrosion resistance of these threads and/or their adhesion to the rubber, for example a thin layer of Co, Ni, Al, of an alloy of two or more of the Cu, Zn, Al, Ni, Co, Sn compounds.

For preference, the reinforcing elements of the at least one hooping layer are made of textile, of aliphatic polyamide, aromatic polyamide or combination of aliphatic polyamide and of aromatic polyamide, polyethylene terephthalate or rayon type, because textile materials are particularly well-suited to this type of use because of their low mass and high rigidity. The distance between consecutive reinforcing elements in the hooping layer may be fixed or variable. The reinforcing elements may be laid during manufacture either in layers, in strips, or individually.

It is advantageous for the hoop reinforcement to be radially on the outside of the working reinforcement in order to ensure good endurance of the latter.

### BRIEF DESCRIPTION OF THE DRAWINGS

The features and other advantages of the invention will be understood better with the aid of FIGS. 1 to 4, the said figures being drawn not to scale but in a simplified manner so as to make it easier to understand the invention:

FIG. 1 is a perspective view depicting part of the tire according to the invention, particularly its architecture and its tread.

FIG. 2 depicts the meridian section through the crown and illustrates the axially exterior parts 22 and 23 of the tread, and the width thereof.

FIGS. 3A and 3B depict two types of radially exterior meridian profile of the tread of a passenger vehicle tire.

FIG. 4 illustrates the terms “interior edge” and “exterior edge” of a tread.

### DETAILED DESCRIPTION OF THE DRAWINGS

FIG. 1 depicts a part of the crown of a tire. The tire comprises a tread 2 which is intended to come into contact with the ground via a tread surface 21. In the axially exterior portions 22 and 23 of the tread there are axially exterior cuts including sipes 24 and grooves 25. The tire further comprises a crown reinforcement 3 comprising a working reinforcement 4 and a hoop reinforcement 5, the working reinforcement comprising two working layers 41 and 42. FIG. 1 further depicts simple and complex blind cuts, double-blind cuts, and cuts opening axially to the outside or to the inside, namely cuts having parallel lateral faces or having lateral faces with zigzag or sinusoidal portions in the main direction of the cut or in the depth thereof, so as to block certain relative movements of the 2 lateral faces.

FIG. 1 depicts in the axially exterior parts 22 and 23 of the tread, only axial axially exterior grooves, running along the axial axis (YY′). In reality, this depiction is pure convenience for the sake of the readability of FIG. 1, it being possible, depending on the performance aims, particularly in terms of wet grip, for the axially exterior grooves in the treads of passenger vehicles to make with the axial direction (YY′) an angle of between plus and minus 60°.

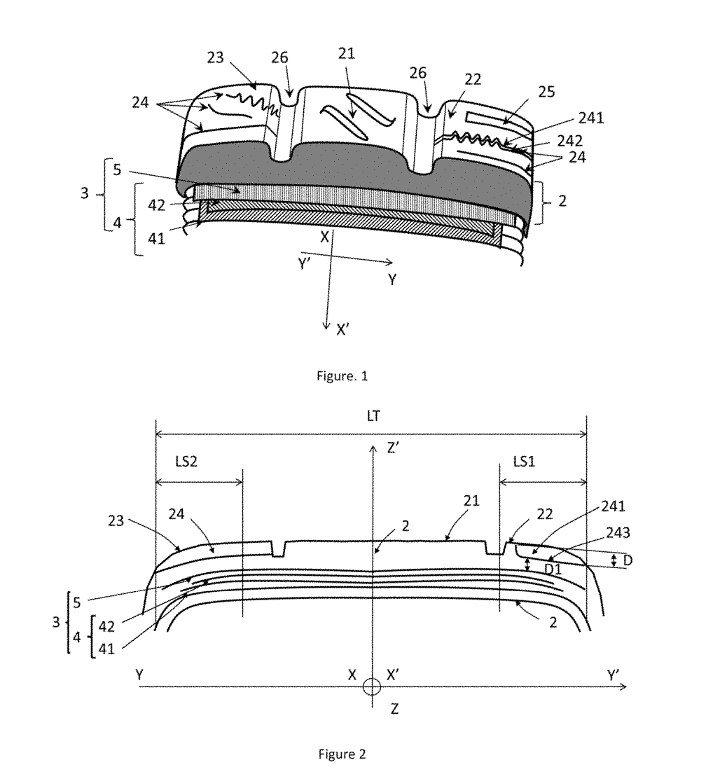

FIG. 2 is a schematic meridian section through the crown of the tire according to the invention. It illustrates in particular the widths LS1 and LS2 of the axially exterior portions 23 and 24 of the tread, and the total width of the tread of the tire LT. The depth D of an axially exterior cut 24, and the distance D1 between the bottom face 243 of an axially exterior cut 24 and the crown reinforcement 3, measured along a meridian section of the tire, are also depicted. A meridian section of the tire is obtained by cutting the tire on two meridian planes. By way of example, a meridian section of tire has a thickness in the circumferential direction of around 60 mm at the tread. The measurement is taken with the distance between the two beads being kept identical to that of the tire mounted on its rim and lightly inflated.

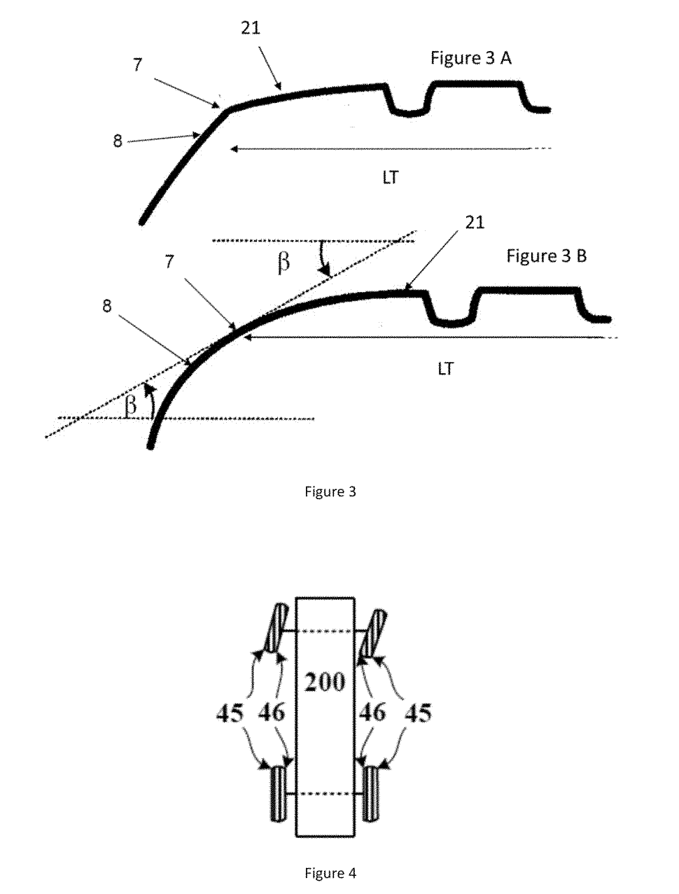

In FIGS. 3A and 3B, the axial edges 7 of the tread, that make it possible to measure the tread width, are determined. In FIG. 3A, in which the tread surface 21 is secant with the exterior axial surface of the tire 8, the axial edge 7 is determined by a person skilled in the art in a trivial way. In FIG. 3B, in which the tread surface 21 is continuous with the exterior axial surface of the tire 8, the tangent to the tread surface at any point on the said tread surface in the region of transition towards the sidewall is plotted on a meridian section of the tire. The first axial edge 7 is the point for which the angle β between the said tangent and an axial direction YY′ is equal to 30°. When there are several points for which the angle β between the said tangent and an axial direction is equal to 30°, it is the radially outermost point that is adopted. The same approach is used to determine the second axial edge of the tread.

FIG. 4 schematically depicts tires mounted on mounting rims of wheels of a vehicle 200 and having a predetermined direction of mounting on the vehicle. Each tire comprises an exterior axial edge 45 and an interior axial edge 46, the interior axial edge 46 being the edge mounted on the bodyshell side of the vehicle when the tire is mounted on the vehicle in the said predetermined direction of mounting, and the exterior axial edge 45 being the opposite of that. In the document, “outboard side of the vehicle” denotes the exterior axial edge 45.

The inventors have performed calculations on the basis of the invention for a tire of size 205/55 R16, inflated to a pressure of 2 bar, comprising two working layers comprising steel monofilaments of diameter 0.3 mm, distributed at a density of 158 threads to the dm and forming, with the circumferential direction XX′, angles respectively equal to 27° and −27°. The monofilaments have a breaking strength Rₘ equal to 3500 MPa and the working layers each have a breaking strength R_{c} equal to 39 000 N/dm. The tire comprises axially exterior cuts on the two axially exterior portions of the tread of the tire having an axial width equal to 0.21 times the axial width of the tread. The radial distance D1 between the bottom face of the axially exterior cuts and the crown reinforcement is at least equal to 2 mm.

Various tires were calculated, varying the thickness and circumferential spacing of the cuts. Tire A, according to the prior art, comprises grooves of rectangular cross section of constant width in the thickness equal to 3.5 mm and depth equal to 6.5 mm. The circumferential spacing of the grooves is 27 mm for 72 grooves on the circumference of the tire. Tire B, according to the invention, comprises sipes of rectangular cross section of constant width in the thickness equal to 1 mm. The circumferential spacing of the sipes is 7.8 mm for 252 sipes on the circumference of the tire. The spacings of the axially exterior grooves and sipes are such that the volume void ratios of the treads of tires A and B are identical. The conditions used for the calculation reproduce the running conditions of a front tire on the outside of the bend, namely the tire that is most heavily loaded in passenger vehicle. These loadings, for a lateral acceleration of 0.7 g, are as follows: a load (Fz) of 749 daN, a lateral load (Fy) of 509 daN and a camber angle of 3.12°. The thickness and the spacing of the cuts, in this instance of the sipes, and their circumferential spacing in the tire B makes it possible, for the same volume void ratio, to reduce the bending stresses in the monofilaments of the working reinforcement by 74% by comparison with tire A, which bending stresses are what causes them to rupture through fatigue loading.

1. A tire for a passenger vehicle, comprising:
a tread adapted to come into contact with the ground via a tread surface and having an axial width LT,
the tread comprising two axially exterior portions each having an axial width at most equal to 0.3 times the axial width LT,
at least one axially exterior portion comprising axially exterior cuts, an axially exterior cut forming a space opening onto the tread surface and being delimited by at least two main faces referred to as lateral faces connected by a bottom face,
the axially exterior cuts having a mean width W, defined by the distance between the two main lateral faces, a depth D defined by the maximum radial distance between the tread surface and the bottom face,
the tire further comprising a crown reinforcement radially on the inside of the tread,
the crown reinforcement comprising a working reinforcement and a hoop reinforcement,
the working reinforcement being comprised of two working layers each comprising reinforcing elements which are coated in an elastomeric material, mutually parallel and respectively form, with a circumferential direction of the tire, an oriented angle at least equal to 20° and at most equal to 50°, in terms of absolute value, and of opposite sign from one layer to the next,
said reinforcing elements in each ply being comprised of individual metal threads or monofilaments having a cross section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm,
the hoop reinforcement comprising at least one hooping layer comprising reinforcing elements which are mutually parallel and form, with the circumferential direction of the tire, an angle B at most equal to 10°, in terms of absolute value,
wherein when the axially exterior cuts have a mean width W at most equal to 1 mm, these axially exterior cuts, referred to as sipes, have a depth D at least equal to 5 mm and are spaced apart, in the circumferential direction of the tire, by a circumferential spacing P at least equal to 4 mm,
and wherein, when the axially exterior cuts have a mean width W at least equal to 1 mm, these axially exterior cuts, referred to as grooves, have a depth D at most equal to 5 mm,
and wherein the breaking strength R_{c} of each working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

2. The tire according to claim 1, wherein at least one said axially exterior cut opens axially to the outside of an axially exterior portion of the tread.

3. The tire according to claim 1, the tread comprising at least one circumferential groove, wherein at least one said axially exterior cut opens axially into a circumferential groove of the tread.

4. The tire according to claim 1, wherein the axially exterior sipes are spaced apart, in the circumferential direction of the tire, by a circumferential spacing P at most equal to 20 mm.

5. The tire according to claim 1, wherein at least one axially exterior sipe is bridged.

6. The tire according to claim 1, wherein the depth D of the axially exterior sipes is at most equal to 8 mm.

7. The tire according to claim 1, wherein the radial distance D1 between the bottom face of the axially exterior sipes and the crown reinforcement is at least equal to 1.5 mm.

8. The tire according to claim 1, wherein the radial distance D1 between the bottom face of the axially exterior sipes and the crown reinforcement is at most equal to 3.5 mm.

9. The tire according to claim 1, wherein all of the axially exterior cuts are sipes.

10. The tire according to claim 1, wherein the two axially exterior portions of the tread each have an axial width at most equal to 0.2 times the axial width LT.

11. The tire according to claim 1, wherein each working layer comprises reinforcing elements made up of individual metal threads or monofilaments having a diameter at least equal to 0.3 mm and at most equal to 0.37 mm.

12. The tire according to claim 1, wherein each working layer comprises reinforcing elements which form, with the circumferential direction of the tire, an angle at least equal to 22° and at most equal to 35°.

13. The tire according to claim 1, wherein the density of reinforcing elements in each working layer is at least equal to 120 threads per dm and at most equal to 180 threads per dm.

14. The tire according to claim 1, wherein the reinforcing elements of the working layers are made of steel.

15. The tire according to claim 1, wherein the reinforcing elements of the at least one hooping layer are made of textile, aromatic polyamide or combination of aliphatic polyamide and of aromatic polyamide, polyethylene terephthalate or rayon type.

16. The tire according to claim 1, wherein the hoop reinforcement is radially on the outside of the working reinforcement.

17. The tire according to claim 1, wherein the steel is carbon steel.

18. The tire according to claim 15, wherein the textile is of aliphatic polymide.
